(19) United States
(12) Patent Application Publication
(10) Pub. No.: US 2011/0078262 A1
(43) Pub. Date: Mar. 31, 2011

(54) ELECTRONIC MAIL ASSISTED COMMUNICATIONS SYSTEM

(76) Inventor: Eric H. Michelman, Bellevue, WA (US)

(21) Appl. No.: 12/892,601

(22) Filed: Sep. 28, 2010

Related U.S. Application Data
(60) Provisional application No. 61/246,400, filed on Sep. 28, 2009.

(51) Int. Cl. G06F 15/16

(52) U.S. Cl. 709/206

(57) ABSTRACT

An email-assisted communication method system that transmits emails to group members to elicit a response in return e-mails. The system receives the elicited return emails response and determines which portions of the elicited return emails are to be transmitted to which group members. The system routes the appropriate portions of the elicited return emails to such group members.

This application claims the benefit of U.S. provisional application No. 61/246,400, entitled “ELECTRONIC MAIL ASSISTED COMMUNICATIONS SYSTEM” filed Sep. 28, 2009.

### TECHNICAL FIELD

This application relates to an Email-Assisted Communications System (EACS), and more specifically to an EACS to assist users to provide details about their lives to other users.

### SUMMARY OF THE INVENTION

An email-assisted communication method and system that transmits emails to group members to elicit a response in a return e-mail is disclosed. The system analyzes the elicited return email response. Based on the response and a preselected configuration, the system automatically and selectively transmits the elicited return email response, either as an aggregation of emails or as individual emails, to selected group members.

In one implementation, one or more initial electronic communication messages is transmitted via a network to elicit return at least one electronic communication message from at least one member of a first group of members, the first group of members being in a plurality of groups of members. From the return communication message, information about the at least one member is determined. Information about the at least one member is used to determine one or more groups of members in the plurality of groups of members to which the at least one member belongs. The return electronic communication message is transmitted to the one or more groups of members in the plurality of groups of members to which the at least one member belongs.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified network diagram of an email assisted communications system;

FIG. 2 is a simplified schematic diagram of a exemplary mobile computing device used in the email assisted communications system;

FIG. 3 is a simplified schematic diagram of an exemplary hosting computing device used in the email assisted communications system;

FIG. 4 is a flow chart of a process for managing and controlling the email assisted communications system using the exemplary hosting computing device shown in FIG. 3; and

FIGS. 5-8 are exemplary emails generated with the email assisted communications system.

### DETAILED DESCRIPTION

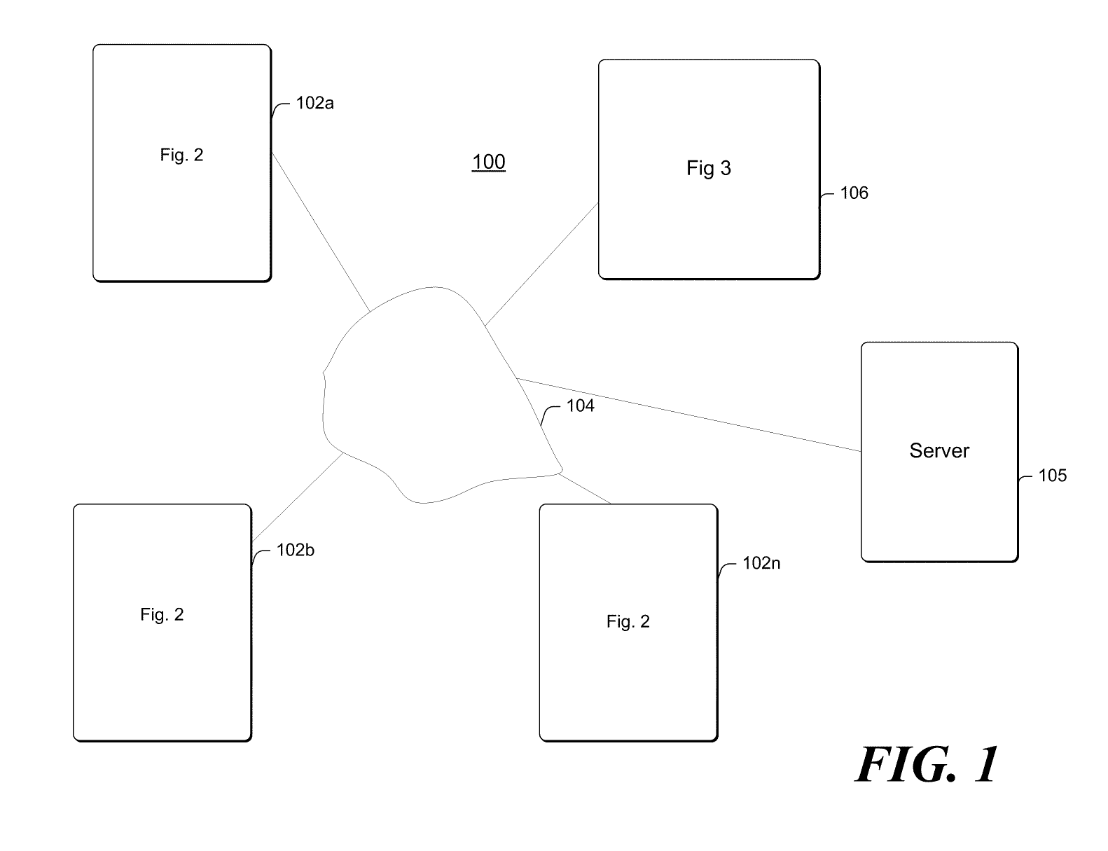

Referring to FIG. 1 there is shown the email assisted communications system (EACS) 100 including computing devices (also referred to herein as a “personal computing device”) 102a-102n coupled via a network 104 to one or more network server devices 105 and to hosting computing device 106 (Also referred herein to as the “EACS hosting device 106”). EACS hosting device 106 is described communicating directly with computing devices 102; however, such communication is for illustration purposes only and in a typical implementation EACS hosting device 106 communicates via network 104 to computing devices 102(a-n). Hosting computing device 106 may be a network computer, host computer, network server, web server, email server or any computing device for hosting email communications applications and systems, one example of which includes a Microsoft® exchange server. Although mobile computing devices 102 are described, devices 102 may be any type of computing device such as a cell phone, laptop, mobile computer, desktop computer, personal computer, PDA, music player or game player device.

In one implementation, EACS 100 works within a community website hosted on computing device 106. On the community website, groups of people can join together to share information, such as details of what is happening in their lives. This information can, for example, include details of activities, family changes, work and school, vacations, travel, or anything else that users wish to share about themselves to their families and friends.

These groups of people can be public (open to anyone to join) or private (only allow others to join by invitation). Each group has their own section of the community website. In accordance with each group's selected preference, the group's section of the website can be viewable by anyone or just members of the group. Each individual user may choose to be a member of one or multiple groups.

Referring to FIG. 1, the EACS hosting device 106 periodically sends an Update Request Email (URE) to personal computing device 102 asking the user of the device 102 to provide an update. These emails may be sent to the personal computing device 102 of all the users, for example it might be desirable for a seasonal update request email about summer plans to be sent to all of the users. Alternatively the emails might be sent to only the personal computing device 102 of some of the users, for example, it might be desirable for an email to be sent to the computing device of only those users who have expressed a particular interest or plans.

### Example Personal Computing Device Architecture

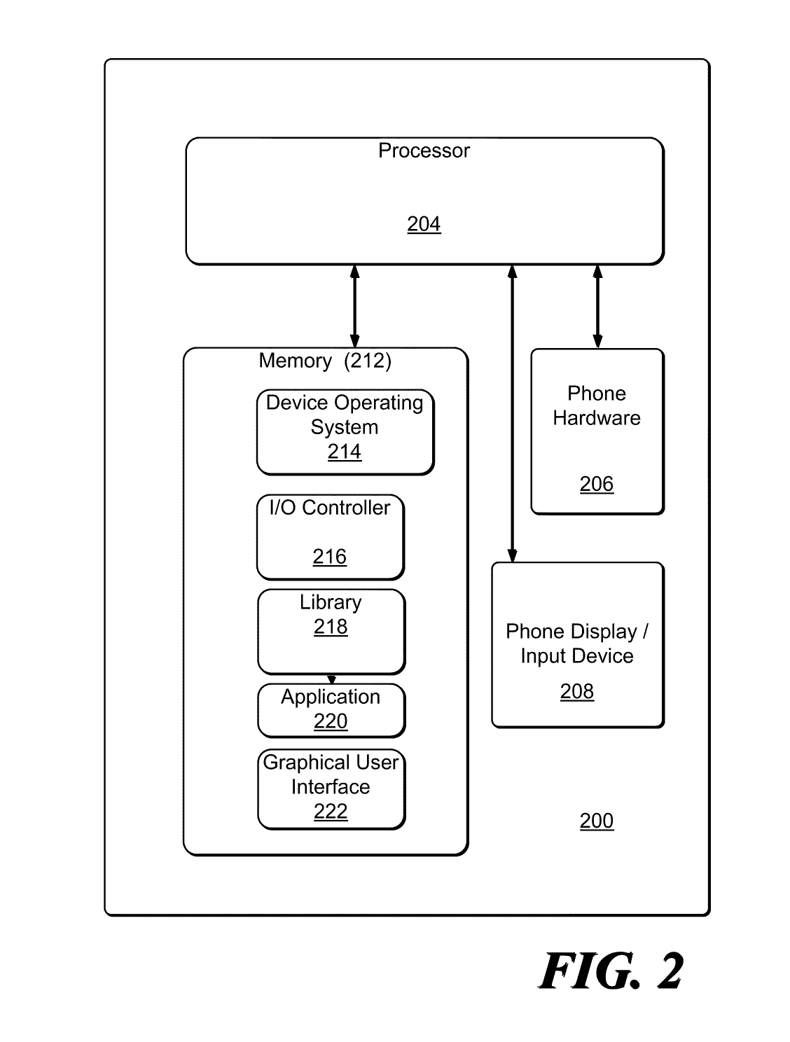

In FIG. 2 there are illustrated selected modules in Personal Computing Device 200. Personal computing device 200 includes a processing device 204, memory 212, hardware 206 and phone display/input device 208. Processing device 204 may include a microprocessor, microcontroller or any such device for accessing memory 212, hardware 206 and device 208. Processing device 204 has processing capabilities and memory suitable to store and execute computer-executable instructions. In one example, Processor 204 includes one or more processors 204.

Processing device 204 executes instructions stored in memory 212, and in response thereto, processes signals from hardware 206 and device 208. Hardware 206 may include network and communication circuitry for communicating with network 104. Display/Input device 208 receives inputs from a user of the personal computing device and may include a keyboard, mouse, track pad, microphone, audio input device, video input device, or touch screen display. Display device 208 may include an LED, LCD, CRT or any type of display device.

Memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Modules stored in memory 212 of the personal computing device 200 may include an operating system 214, an I/O controller 216, a library 218, an email application 220 and a graphical user interface 222. Operating system 214 may be used by application 220 to operate device 200. I/O controller may provide drivers for device 200 to communicate with hardware 206 or device 208. Library 218 may include preconfigured parameters (or set by the user before or after initial operation) such personal computing device operating parameters, and configurations.

### Example Host Computing Device Architecture

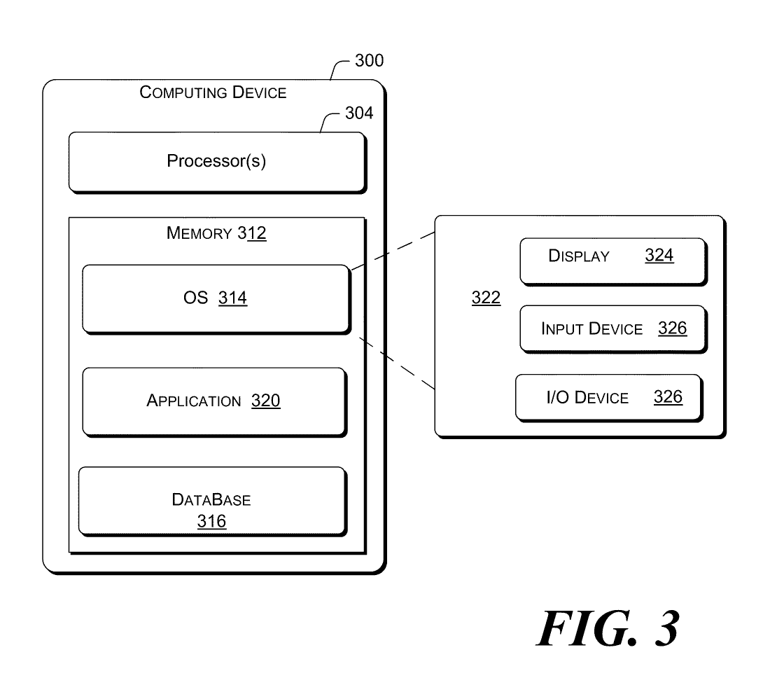

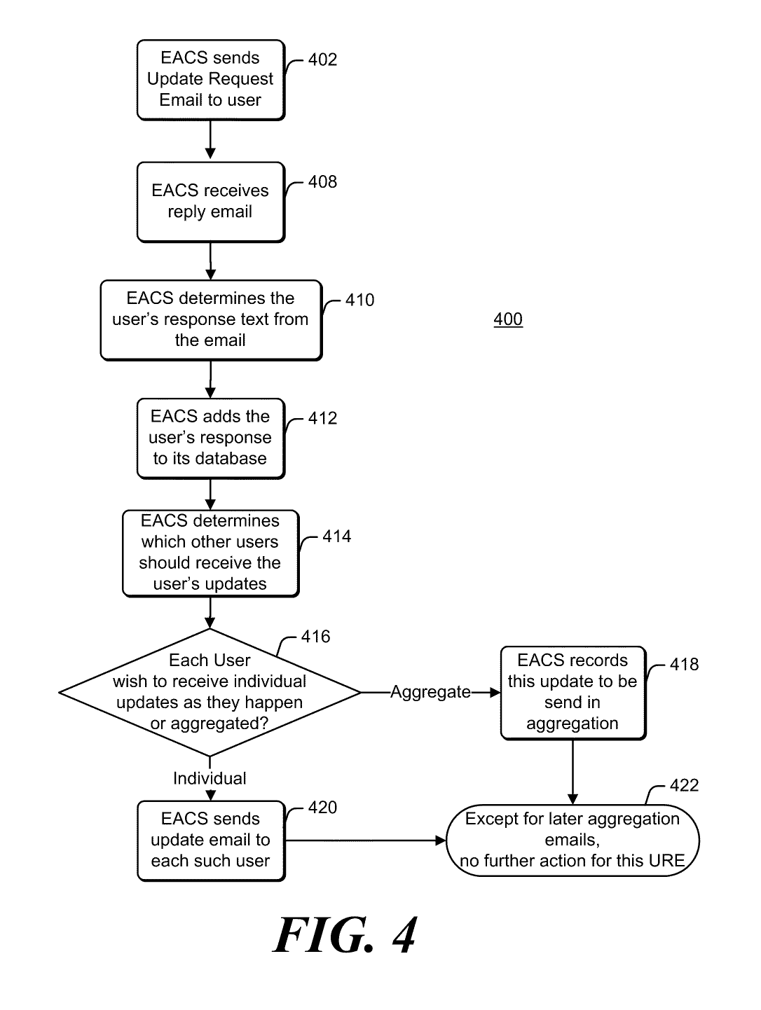

In FIG. 3 there are illustrated selected modules in host computing device 300 (Device 106 of FIG. 1) using an optional process 400 shown in FIG. 4. Hosting device 300 includes a processing device 304, memory 312, and hardware 322. Processing device 304 may include one or more a microprocessors, microcontrollers or any such devices for accessing memory 312 or hardware 322. Processing device 304 has processing capabilities and memory suitable to store and execute computer-executable instructions.

Processing device 304 executes instruction stored in memory 312, and in response thereto, processes signals from hardware 322. Hardware 322 may include a display 324, and input device 326 and an I/O device 326. I/O device 326 may include a network and communication circuitry for communicating with network 104. Input device 326 receives inputs from a user of the host computing device 300 and may include a keyboard, mouse, track pad, microphone, audio input device, video input device, or touch screen display. Display device 324 may include an LED, LCD, CRT or any type of display device.

Memory 312 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 312 of the hosting device 300 may include an operating system 314, an email assisted communications system application 320 and a library of other applications such as a database 316. Operating system 314 may be used by application 320 to operate device 300. The operating system 314 may include drivers for device 300 to communicate with I/O device 326. Database 316 may include preconfigured parameters (or set by the user before or after initial operation) such web site operating parameters, web site libraries, HTML libraries, API's and configurations.

A process 400 for an email assisted communication system application is described in FIG. 4. Such an exemplary process 400 may be a collection of blocks (402-422) in a logical flow diagram, which represents a sequence of operations that can be implemented in hardware, software, and a combination thereof. In the context of software, the blocks may represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

Referring to FIG. 4, a flowchart of process 400 executed by the EACS application 320 (hereafter referred to as EACS 320) is shown. When EACS 320 is executed by the host processing devices, it uses the processor 304 and modules 312-316 that are shown in FIG. 3.

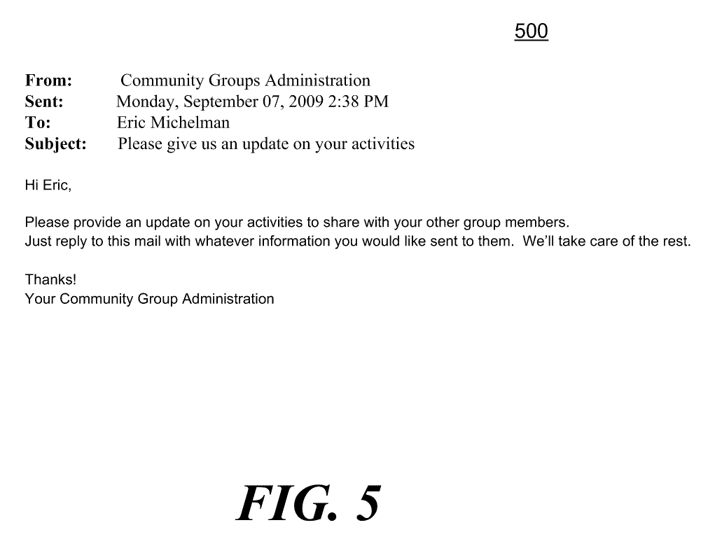

In block 402, EACS 320 sends an initial Update Request Email (URE) to a user of a personal computing device (e.g. personal computing device 102a in FIG. 1). Referring to FIG. 5 there is shown an example of a URE as it may appear to a receiving user on display a personal computing device 200a. EACS 320 may use a generic e-mail application to send and receive e-mails generated by process 400 on the host device 300. The sent URE message may also include instructions for how to reply, including how to optionally specify particular family/group members or particular groups as described below.

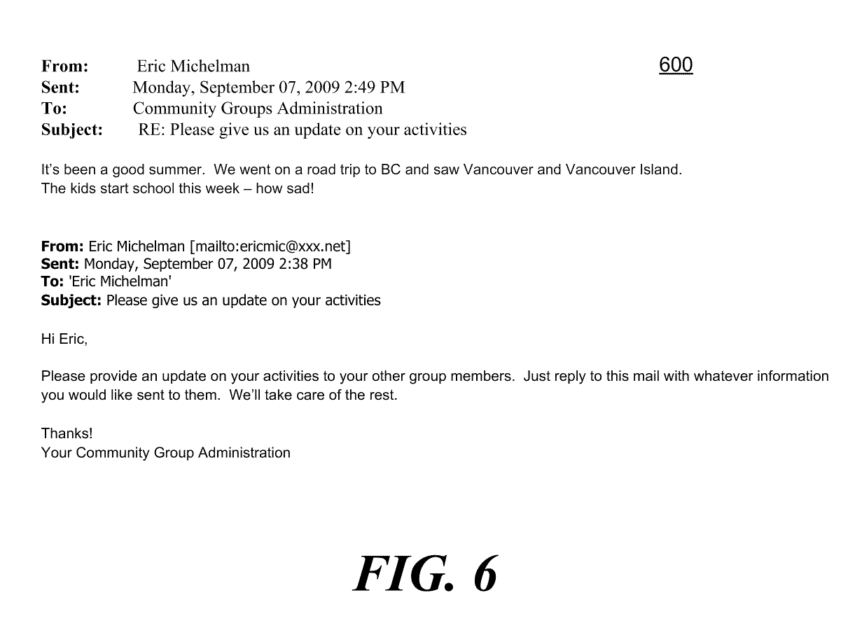

Each user, if they wish to participate, replies to the email with an update message (URE response) using a normal email Reply function on their personal computing device. The reply message is sent back to the host device 300. FIG. 6 shows an example 600 of a URE response email as it may appear on the display of the personal computing device to the user sending the response.

In block 408, the EACS 320 receives a return email from the user personal computing device (such as device 102a) containing the URE response.

In block 410, EACS 320 determines which portion of the email the user typed in the reply, and filters the email by separating out that portion from the initially sent email and any other email content. In one implementation, there are a number of rules and heuristics which are used to separate out the reply text, including:
1. Remove the standard “From”, “To”, “Subject”, “Date”, “CC”, and “BCC” lines.
2. If the original email text is included in the reply (as is commonly done with emails), remove the text for it, including the “From”, “To”, “Subject”, “Date”, “CC”, and “BCC” lines for that email.
3. Remove any non-text formatting characters, such as a horizontal divider above the original email text.
4. Remove any advertising text that may have been placed at the bottom of the reply or elsewhere in the reply by the email system.
5. Remove any lines containing common command text such as Print.

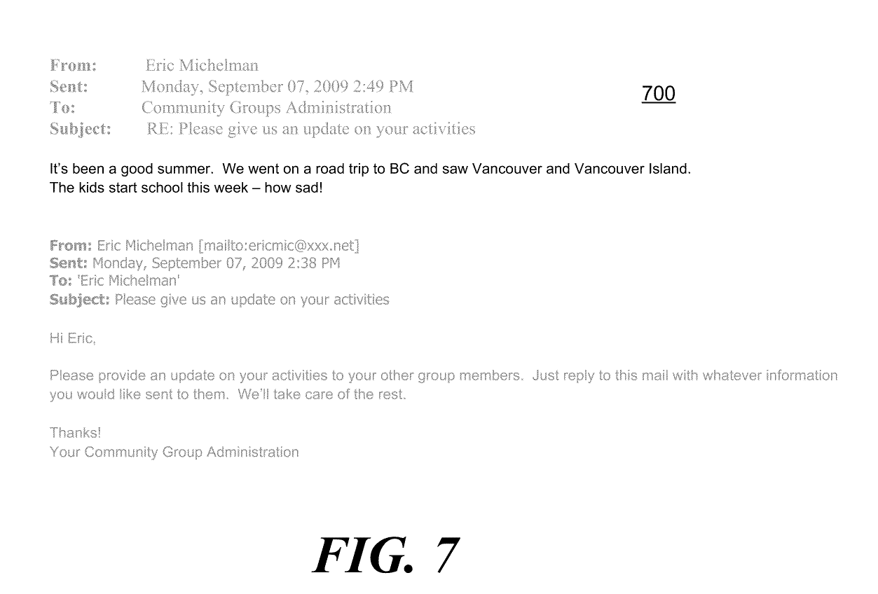

FIG. 7 shows the portion 700 of the example response email that the EACS pulls out as the sender's reply.

Optionally as a check, after the EACS 320 determines the user's response from the URE reply email in block 410, the EACS 320 may email the URE reply back to the personal computing device of the user with an indication of what the EACS determined as the user's reply to give the user an opportunity to correct the URE reply in case it was incorrectly determined. In one implementation, this confirmation email also contains instructions to the user on how to reply along with instructions on options such as how to specify that the reply pertains to a particular family member or group.

In block 412, the EACS then adds the user's reply text to the user's information that it maintains in its database.

Optionally when replying to a URE, a user can specify, using its personal computing device, to which family member(s) an update pertains. Different updates for different family members can be provided. One approach to specifying to which family member(s) an update pertains is to lead the update (or different segments within an update) with a family member's name followed by a semi-colon or other delimiter.

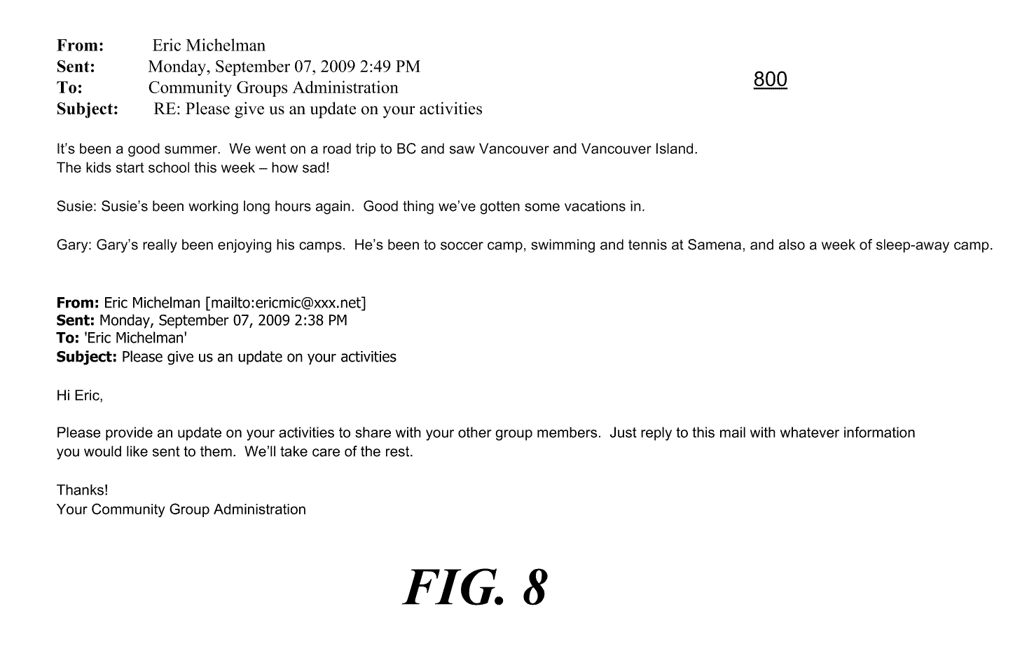

FIG. 8 shows an example 800 of such a URE response in which the first part of the response pertains to the entire family, and in which parts pertain to exemplary friends Susie and Gary.

In another implementation, users can provide updates with their personal computing device directly through the web site using a browser on their device.

Referring to FIG. 4, in block 414, the EACS 320 determines which other users should receive the user's updates. When the user's information is updated either via Update Request Emails or through the web site, the update is sent by email to the members of the groups that the user belongs. By default the update is sent to all groups that the user belongs, but the user may restrict the update to certain groups. This restriction may be for a particular update, for a particular time period, or as an on-going (but changeable) default. One option for restricting an update to a particular group is, similarly to specifying family members, to lead the update (or different segments within an update) with a group's name followed by a semi-colon or other delimiter. This lead may even be combined with a family member specification, such as “Susie: Friends from home: here's my update . . . ”.

When the EACS 320 sends updates to group members, the EACS 320 makes a determination in block 416 to either send them updates one at a time in block 420 or saves and aggregates the updates over settable time periods in block 418, later sending the aggregation of updates as one email (in this case the sending is not shown in this flowchart). When updates are aggregated, all the updates coming to each individual user are saved in the database 316 and then later assembled together into a single email, including updates the individual user received from all other users in all their groups (such as users of devices 102b and 102n). In block 422, except for later aggregation emails, no further action is taken for this Update Request Email. In short, this aggregation allows each user to receive a single periodic email for all the updates coming to them. In one implementation, this option is specified by each user according to their preference, including whether to aggregate all groups' updates, certain groups' updates or do not aggregate, and if an aggregated update is to be provided the preference may include how often to send the aggregated updates. Each user may also specify on their personal computing device 102 that they do not wish to receive update emails and the EACS 320 does not send update emails to such users.

Users can also view on their personal computing device other group members' updates via the web site, as well see their own updates and make modifications to the updates if they wish.

The EACS 320 sends out the Update Request Emails at different times, including:
At regular time intervals.
Seasonally, to collect seasonal information, such as requesting summer or school plans, or Christmas or Thanksgiving plans.
For special events, such as group member's birthdays.

When a group member's birthday is coming up, the EACS 320 may send out a special URE which is a Birthday Wishes Request Email (BWRE) to all the other group members. The other members can respond with birthday wishes for that member. The EACS may aggregate the messages containing the wishes and send them all together to the member. The aggregation may be presented as a birthday card, including optionally having the visual appearance of an on-line birthday card. Similarly other special URE's may be sent on other occasions such as Christmas, Mothers Day, Fathers Day, Thanksgiving, and other occasions.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

1. An apparatus comprising:
a computing device for transmitting one or more initial electronic communication messages to elicit at least one return electronic communication message from at least one member of a first group of members, the first group of members being in a plurality of groups of members, for determining from the return communication message information about the at least one member, for using information about the at least one member to determine one or more groups of members in the plurality of groups of members to which the at least one member belongs, and for transmitting to the one or more groups of members in the plurality of groups of members to which the at least one member belongs the return electronic communication message.

2. The apparatus as recited in claim 1, wherein the computing device is operative to receive at least one return electronic communication message from a second member in the plurality of groups of members, and for aggregating return electronic communication messages from the at least one member and the second member determined by the computing device to be transmitted to a first member in the plurality of groups of members, and for transmitting to the first member the aggregated return electronic communication messages.

3. The apparatus as recited in claim 1, wherein the computing device is operative to filter the return electronic communication message to separate portions from the return electronic communications message for distribution to different members in the plurality of groups of members.

4. The apparatus as recited in claim 1, wherein the computing device is operative to filter the return electronic communication message to separate portions from the return electronic communications message for distribution to all members of only one second group of members in the plurality of groups of members.

5. The apparatus as recited in claim 1, wherein the apparatus is operative to filter the return communications messages to separate out portions of the return electronic communications message by performing at least one of:
a. Removing the standard “From”, “To”, “Subject”, “Date”, “CC”, or “BCC” lines from the return electronic communications message;
b. Removing any non-text formatting characters from the return electronic communications message;
c. Removing advertising text from the return electronic communications message; and
d. Removing text lines containing common command text from the return electronic communications message.

6. The apparatus as recited in claim 1, wherein the computing device is operable to transmit the initial electronic communication messages to a communication device of the at least one member and to transmit at least a portion of the return communication message to the communication device to give the at least one member an opportunity to correct the return communication message.

7. The apparatus as recited in claim 1, wherein the computing device is operative to analyze the return communication to determine to which people having a relationship to the first member in the first group of members certain portions of the return communication pertain.

8. The apparatus as recited in claim 2, wherein the computing device is operative to receive return communication messages that include update messages from the at least one member and the second member, wherein the computing device is operative to aggregate the update message from the at least one member with update messages provided from the second members before being provided as an aggregated update message to the first member.

9. The apparatus as recited in claim 1, wherein the computing device is operative to transmit the one or more initial communication messages at regular time intervals, seasonally or for special events.

10. The apparatus as recited in claim 1 wherein the at least one member is a member of at least two groups of members in the plurality of groups of members.

11. An email-assisted communication method comprising:
transmitting one or more initial electronic communication messages to elicit at least one return electronic communication message from at least one member of a first group of members, the first group of members being in a plurality of groups of members;
determining from the return communication message information about the at least one member;
using information about the at least one member to determine one or more groups of members in the plurality of groups of members to which the at least one member belongs; and
transmitting to the one or more groups of members in the plurality of groups of members to which the at least one member belongs the return electronic communication message.

12. The method as recited in claim 11, further comprising:
analyzing the return communication to determine to which people having a relationship to the one member of a first group of members certain portions of the return communication pertain.

13. The email-assisted communication method as recited in claim 11 comprising:
transmitting the return electronic communication messages to the one or more groups of members in the plurality of groups of members to which the at least one member belongs based on a preselected configuration as an aggregation of emails or individual emails.

14. The method as recited in claim 11 further comprising determining from the return communication message which members of other groups of members in the plurality of groups of members should receive the elicited return e-mails responses.

15. The method as recited in claim 1 further comprising:
filtering the return electronic communication message to separate portions from the return electronic communications message for distribution to all members of only one second group of members in the plurality of groups of members.

16. A computer readable medium having instruction stored in a memory, which when executed by a processor comprises:
transmitting one or more initial electronic communication messages to elicit at least one return electronic communication message from at least one member of a first group of members, the first group of members being in a plurality of groups of members;
determining from the return communication message information about the at least one member;
using information about the at least one member to determine one or more groups of members in the plurality of groups of members to which the at least one member belongs; and
transmitting to the one or more groups of members in the plurality of groups of members to which the at least one member belongs the return electronic communication message.

17. The computer readable medium as recited in claim 16, wherein the return electronic communication messages has the visual appearance of a birthday or holiday card.

18. An email-assisted communication method comprising:
determining when an event pertaining to a group member of one or more groups is approaching;
transmitting emails to the other members of the one or more groups soliciting comments in return emails regarding the event;
extracting responses from return emails; and
sending the responses together as a group email to a group member of the one or more groups.

19. The method as recited in claim 19, wherein the responses sent together as a group email has the visual appearance of a birthday or holiday card.
